(19) United States
(12) Patent Application Publication
(10) Pub. No.: US 2017/0136511 A1
(43) Pub. Date: May 18, 2017

(54) DEVICE FOR THE CONTACT-FREE CLEANING OF ROLLERS, AND METHOD THEREFOR

(71) Applicants: ThyssenKrupp Steel Europe AG, Duisburg (DE); ThyssenKrupp AG, Essen (DE)

(72) Inventors: Marc Blumenau, Dortmund (DE); Sahin Cengiz, Dortmund (DE); Erhard Klemm, Dortmund (DE); Oliver Moll, Wesel (DE); Roger Nüssen, Lünen (DE); Christian Schmidt, Dortmund (DE); Michael Ullmann, Bochum (DE); Udo Zocher, Selm (DE)

(73) Assignees: ThyssenKrupp Steel Europe AG, Duisburg (DE); ThyssenKrupp AG, Essen (DE)

(21) Appl. No.: 15/128,591

(22) PCT Filed: Mar. 23, 2015
(86) PCT No.: PCT/EP2015/056106

§ 371 Date: Sep. 23, 2016

(30) Foreign Application Priority Data
Mar. 28, 2014 (DE) 10 2014 004 487.4

(51) Int. Cl. B21B 28/04; B08B 5/02

(52) U.S. Cl. CPC B21B 28/04; B08B 5/026; B21B 2001/228

(57) ABSTRACT

Devices and methods for cleaning a roller of a system for processing strip-type material may involve a suction duct in addition to a nozzle that directs a gas flow onto a surface of the roller. The nozzle and the suction duct may be disposed in a hood that covers part of a circumference of the roller. Further, the nozzle can be disposed at an angle within a range of ±45 degrees with respect to a normal line extending orthogonally from the surface of the roller. Moreover, the nozzle may be spaced less than 50 mm apart from the surface of the roller.

In the rolling and dressing of metals, in particular of metal strips, for example of steel, aluminum, magnesium or of other non-ferrous metals, abrasion is inevitably created both from the rollers per se as well as from the strip surface. In order for this abrasion not to create quality deficiencies on the strip surface, for example by way of contamination or imprints, said abrasion has to be removed.

A usual method is removal by spraying on a liquid such as water, an emulsion, or the like. This is referred to as wet rolling or wet dressing, respectively. However, as an alternative in particular for special product and quality requirements, for example in the case of products which are particularly prone to corrosion, rolling or dressing, respectively, may also be performed without a liquid. This is referred to as dry rolling or dry dressing, respectively.

In the prior art, mechanical contacting methods such as brushes or scraping blades which remove adhering particles or a compacted contaminant layer from the roller surface are employed for dry rolling or dry dressing, respectively. Conventional cleaning systems such as brushes are based on a contacting operating principle. For reasons of wear, said conventional cleaning systems have to be often replaced and cleaned, and they lead to abrasive wear of the roller surface. Roller cleaning by contacting systems is thus intensive in terms of interference and maintenance. Moreover, the solutions included in the prior art are capable of being retrofitted to already existing rolling stands or dressing stands, respectively, with difficulty and are subject to intensive wear in daily use. Apart from the investment costs, these systems are thus also associated with relatively high operating costs.

The invention is based on the object of providing a device and a method for cleaning rollers, in particular support and/or worker rollers in a strip-processing plant, in particular of rolling stands or dressing stands, respectively. Especially for dry rolling or dry dressing, respectively. The disadvantages of the solutions known from the prior art (heavy wear, intensive in terms of maintenance, complex construction modes, . . . ) are to be avoided in particular herein.

A dressing stand or rolling stand, respectively, is typically composed of a pair of work rollers which are in direct contact with the strip surface, and a support-roller pair (a so-called four-high stand) or a system of a plurality of support rollers (for example a six-high dressing stand or other systems) which stabilize and drive the work rollers.

A massive precipitation of dust (“glitter” or “dressing dust”), in particular of abrasion from the strip material and from the work rollers, which causes the build-up of a contaminant layer on the roller surface above all on the support rollers arises during dry rolling or dry dressing. This contaminant layer may peel or be transferred on to the work rollers, on account of which impressions on the strip surface arise.

The device according to the invention, or the method according to the invention, respectively, serves for continuously cleaning rollers by way of a combined suction-blower device. By permanently blowing down the roller surface, the abrasion which is created during rolling is continuously stripped, the formation of a contaminant layer on the roller surface thus being suppressed. The rolling dust may be directly evacuated by the combination with an integrated suction unit. On account thereof, a complete housing of the rolling stand or the dressing stand, respectively, may be dispensed with.

Both blowing down of the roller surface as well as suctioning the dust (“glitter”) take place within a common housing (hood) which is positioned so as to be close to the surface to be cleaned but so as not to contact the latter.

The hood and the effective range of the gas flow or fluid flow (blown air) that is blown in covers the complete operating width of the roller to be cleaned, said operating width corresponding to at least the width of the metal strip. The blown air is thus ideally blown down by way of a slit nozzle or a nozzle beam from a plurality of individual nozzles which in the width direction of the roller extend at least across the width of the strip material. From an economic standpoint, air or compressed air, respectively, is used as gas.

A closer observation of the incoming and outgoing flows is decisive for optimum operation. In this way, the inward air flow has to be dimensioned such that the particles adhering to the roller surface are released. The nozzle shape herein also has particular significance. In one exemplary embodiment, the nozzle is embodied in the form of a Venturi nozzle, on account of which the amount or the velocity of the gas flow may be increased, respectively. In a further exemplary embodiment, the geometry of the nozzle is configured in such a manner that the gas flow is directed onto the surface in a concentrated manner by utilizing the Coanda effect.

The flow in the hood must be designed such that no so-called dead zones that facilitate deposits of the dressing dust on the wall of the suction hood arise within the hood. In general, as laminar as possible, i.e. largely turbulence-free flow conditions are guaranteed by rounded edges and transitions and/or flowing continuous faces. Furthermore, suctioning of the hood has to be set such that the dressing dust may be entirely removed from the hood.

Herein, fresh air and exhaust air have to be set so that no positive pressure which ejects particles from the gap between the hood and the roller surface is created in the hood.

Hereunder, an embodiment of the invention for cleaning a roller of a system for processing strip-type material is described, wherein at least one nozzle which directs a fluid flow onto the surface of the roller, and at least one suction duct are provided. The at least one nozzle and the at least one suction duct are disposed in a common hood, and the hood covers part of the circumference of the roller.

The suction performance, i.e. the volumetric flow, of the at least one suction duct which is disposed in the hood is greater than the fluid flow that is introduced by means of the at least one nozzle which is disposed in the hood. In one preferred embodiment, the volumetric flow of the exhaust air is thus set so as to be greater than the blown-in gas flow by 5% to 50%.

The at least one nozzle covers at least a width of the roller that corresponds to the width of the strip-type material. The at least one nozzle is disposed at an angle of +/−45°, preferably +/−10°, in particular 0°, in relation to the vertical to the surface of the roller and at a spacing of less than 50 mm, preferably of 1 mm to 30 mm from the surface of the roller.

In order for the width to be covered, the at least one nozzle is configured as a slit nozzle or as a nozzle beam having a plurality of individual nozzles disposed beside one another, wherein the individual nozzles per se may be configured so as to be punctiform or slit-shaped.

The fluid flow or gas flow, respectively, exits from the at least one nozzle at a velocity of at least 20 m/s, preferably of more than 40 m/s. The maximum nozzle spacing depends on the opening and thus on the shape of the nozzle and on the flow velocity resulting therefrom. Said nozzle spacing in the case of a nozzle having a 4 mm opening is approx. 50 mm. A particularly good cleaning effect is achieved with nozzle spacings which are approx. 1 to 30 mm from the roller surface.

In order for the cleaning effect to be further increased, in one exemplary embodiment means for at least temporarily introducing abrasive particles to the gas flow are provided in the at least one nozzle or the infeeding line thereof. Said particles are corundum-based particles as known from processing by blasting for example.

For maintenance purposes, and for replacing the rollers, and for adapting to various roller diameters, the cleaning device according to the invention is adjustably attached to the rolling stand.

In one further embodiment, at least one further suction duct which preferably extends across a width which corresponds to the width of the strip-type material is provided and is disposed outside of the hood in the region of the contact point preferably in the exit direction with an adjacent roller or with the strip-type material.

Further details and features of the invention are derived from the drawings and the description hereunder by means of the schematic illustrations. The figures merely illustrate exemplary embodiments in a schematic manner. Same parts are referenced using identical reference signs.

FIG. 1 shows a cleaning device according to the invention, when viewed in the direction of the roller width.

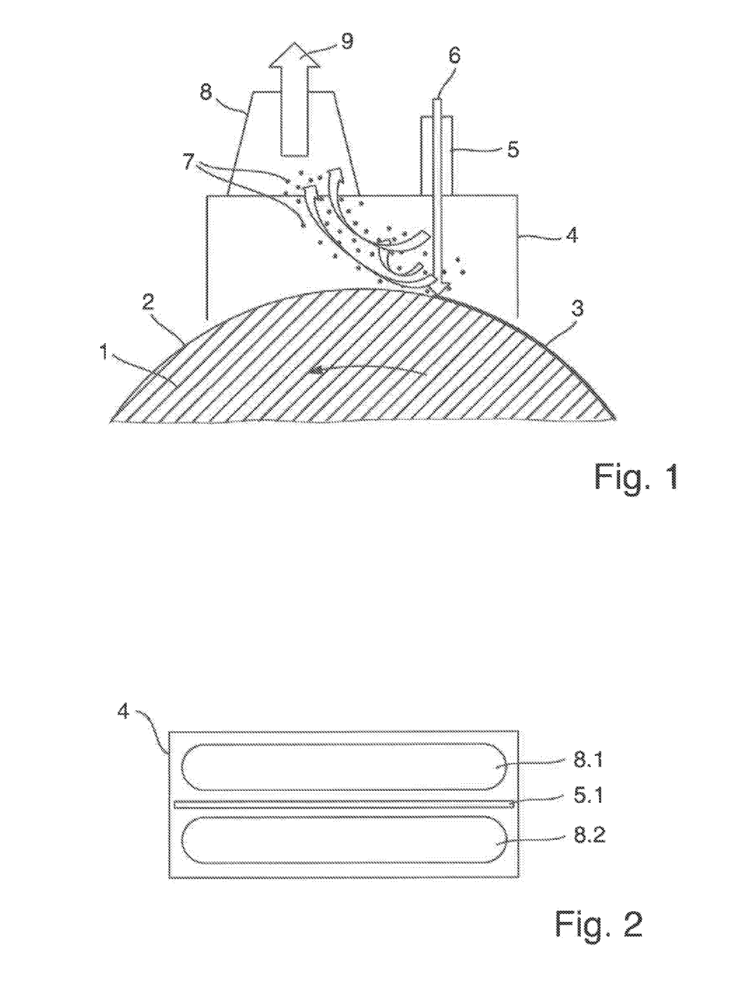

FIG. 2 shows a further cleaning device according to the invention, when viewed from the direction of the roller surface.

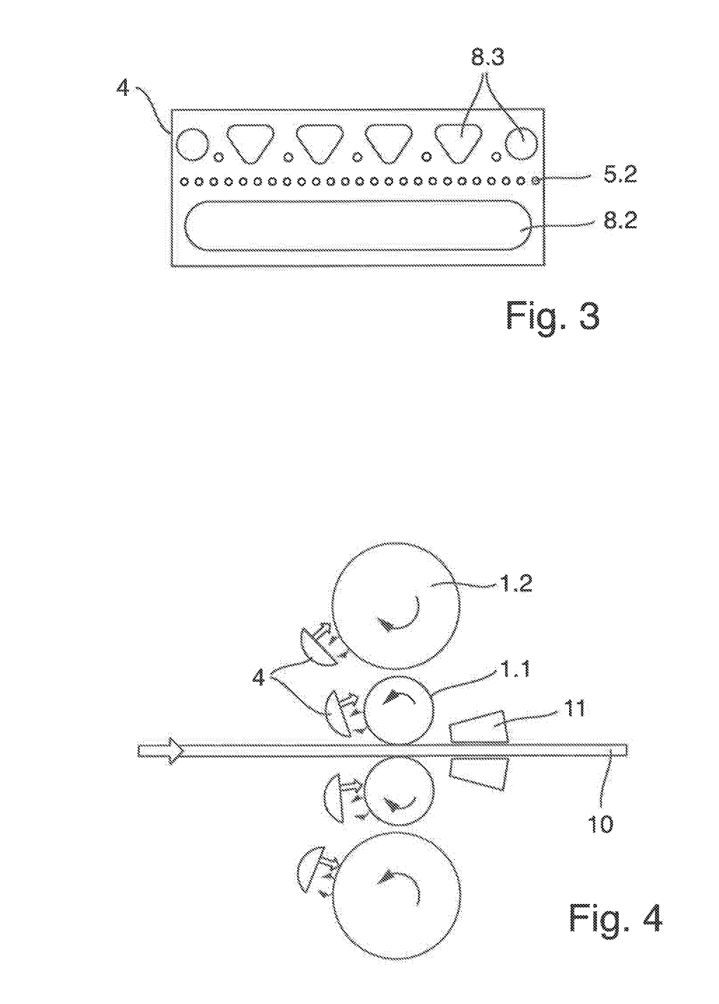

FIG. 3 shows a further cleaning device according to the invention, when viewed from the direction of the roller surface.

FIG. 4 shows a rolling stand having cleaning devices according to the invention.

### Reference Signs

1 Roll
1.1 Work roll
1.2 Support roll
2 Roller surface
3 Contaminant layer
4 Hood
5 Nozzle
5.1 Slit nozzle
5.2 Nozzle beam
5.3 Individual nozzle
6 Gas flow
7 Particles
8 Suction duct
8.1 First suction duct
8.2 Second suction duct
8.3 Individual suction duct
9 Exhaust air
10 Strip material
11 Further suction duct

A roller (1) having a contaminant layer (3) which adheres to the roller surface (2) is illustrated in FIG. 1. A hood (4) according to the invention has been offered up to the roller surface (2), wherein this hood (4) does not contact the roller surface (2). At least one nozzle (5) is provided in the direction of the width in the hood (4), from which nozzle a gas flow (6) is blown down at a velocity of more than 20 m/s, preferably more than 40 m/s onto the roller surface (2) having the contaminant layer (3). For reasons of economy, velocities in excess of 500 m/s are no longer expedient. Furthermore, velocities below 300 m/s are preferable for reasons of noise abatement. The contaminant layer (3) is released from the roller surface (2) by the gas flow (6), and the particles (7) created are extracted together with the exhaust air (9) through at least one suction duct (8). The volumetric flow of the exhaust air (9) herein is dimensioned such that the former is greater than the volume of the gas flow (6) that is infed by way of the at least one nozzle (5).

FIG. 2 illustrates a hood (4) when viewed from the direction of the roller surface, wherein the at least one nozzle (5) is embodied as a slit nozzle (5.1). Slit nozzles (5.1) or flat slit nozzles of this type are known as pneumatic blades or air knives. The slit nozzle (5.1) extends across the width of the hood (4) and in one embodiment is provided in an approximately centric manner. In the embodiment illustrated, two suction ducts (8) are provided on the hood (4), wherein the first suction duct (8.1) when viewed in the rotation direction of the roller is located ahead of the slit nozzle (5.1), extending across a large part of the width of the hood (4). Additionally, a second suction duct (8.2) is provided on the trailing side of the slit nozzle (5.1) when viewed in the rotation direction of the roller. However, the symmetrical construction shown in FIG. 2 is not mandatory but does have the advantage that the installation may be performed independently of the rotation direction.

In one further embodiment, only one of the two suction ducts (8.1 or 8.2) is provided. On account thereof, a smaller installation space of the hood (4) may be implemented, this simplifying the installation and the repositioning capability of the hood (4). Instead of the width shown, the suction ducts (8) may also be composed of a plurality of individual suction ducts disposed beside one another.

The embodiment shown in FIG. 3 is likewise viewed from the direction of the roller surface. However, the at least one nozzle (5) herein is configured in the form of a nozzle beam (5.2) which in the direction of the width is composed of a multiplicity of individual nozzles disposed beside one another. Further additional individual nozzles (5.3) are provided on the leading side of the nozzle beam (5.2) in the rotation direction, the contaminant layer (3) being burst open thereby already ahead of the nozzle beam (5.2), on account of which the cleaning effect may be further improved. A plurality of suction ducts (8.3) are provided ahead of the additional individual nozzles (5.3) and therebetween. As is the case in the exemplary embodiment shown in FIG. 2, a second suction duct (8.2) is provided after the nozzle beam (5.2). Of course, the second suction duct (8.2) need not to be embodied as illustrated as an individual duct which extends approximately across the width of the hood (4), but may be subdivided into a plurality of individual suction ducts (8.3).

FIG. 4 schematically shows a rolling stand having two work rollers (1.1), the strip material (10) to be processed running through therebetween. The work rollers (1.1) are supported by a pair of support rollers (1.2). In the case of the device according to the invention, the hoods (4) may be provided on the work rollers (1.1) as well as on the support rollers (1.2). In consideration of the quality requirements, the disposal of the hoods (4) and thus the cleaning is performed on the work rollers (1.1), preferably on the entry side of the strip (10).

In one further embodiment, further suction ducts (11) for suctioning free particles are provided. The further suction duct (11) preferably has a width that corresponds to the width of the strip-type material and in the exit direction is disposed in the region of the contact point between the work roller (1.1) and the strip (10). Further suction ducts (11) may additionally or alternatively be disposed in the proximity of the contact points between the work roller (1.1) and the support roller (1.2), or between support rollers (1.2), respectively.

1-16. (canceled)

17. A device for cleaning a roller of a system for processing strip-type material, the device comprising:
a hood configured to cover part of a circumference of a roller;
a nozzle that is disposed in the hood and is configured to direct a gas flow onto a surface of the roller; and
a suction duct disposed in the hood.

18. The device of claim 17 wherein the nozzle is configured to cover at least a width of the roller corresponding to a width of a strip-type material carried along or supported by the roller.

19. The device of claim 17 wherein the nozzle is configured to be positioned at an angle within a range of ±45 degrees with respect to a normal line extending from the surface of the roller.

20. The device of claim 17 wherein the nozzle is configured to be spaced less than 50 mm from the surface of the roller.

21. The device of claim 17 wherein the hood comprises internal faces, wherein either the internal faces of the hood are continuous or the hood comprises rounded transitions between the internal faces.

22. The device of claim 17 wherein the nozzle is configured to cover at least a width of the roller corresponding to a width of a strip-type material carried along or supported by the roller, wherein the nozzle is configured to be positioned at an angle within a range of ±45 degrees with respect to a normal line extending from the surface of the roller, wherein the nozzle is configured to be spaced less than 50 mm from the surface of the roller.

23. The device of claim 22 wherein an amount of suction in terms of volumetric flow created by the suction duct is greater than the gas flow of the nozzle.

24. The device of claim 22 wherein the nozzle is configured as a slit nozzle or as a nozzle beam having a plurality of individual nozzles disposed beside one another.

25. The device of claim 22 wherein the gas flow directed by the nozzle composes air and exits the nozzle at a velocity of at least 20 m/s.

26. The device of claim 22 wherein the nozzle is a first nozzle, the device further comprising a second nozzle that is disposed ahead of the first nozzle with respect to a rotation direction of the roller.

27. The device of claim 22 wherein the nozzle and an infeed line to the nozzle are capable of receiving abrasive particles to be directed as part of the gas flow.

28. The device of claim 22 wherein the nozzle is configured to be disposed perpendicular to the roller surface and configured to be spaced 1-30 mm apart from the roller surface.

29. The device of claim 22 wherein the suction duct is a first suction duct, the device further comprising a second suction duct configured to be positioned across a width of the roller corresponding to a width of a strip-type material carried along or supported by the roller, wherein the second suction duct is disposed outside the hood in a region proximate at least one of the strip-type material or an adjacent roller.

30. A method for cleaning a roller of a system for processing strip-type material, the method comprising:
directing a gas flow from a nozzle within a hood onto a surface of the roller such that the gas flow is directed at least across a width of the roller corresponding to a width of the strip-type material that comes in contact with the roller, wherein the gas flow is directed onto the surface of the roller at an angle within a range of ±45 degrees with respect to a normal line extending from the surface of the roller, with the nozzle being positioned less than 50 mm from the surface of the roller, wherein the hood covers a part of a circumference of the roller; and
removing glitter and dissolved contaminants by way of a suction duct disposed in the hood.

31. The method of claim 30 wherein a volumetric flow created by the suction duct is greater than the gas flow created by the nozzle.

32. The method of claim 30 wherein the gas flow composes air and exits the nozzle at a velocity of at least 20 m/s.

33. The method of claim 30 further comprising directing a second gas flow from a second nozzle onto the surface of the roller, wherein with respect to the roller the second gas flow is circumferentially-offset from the gas flow from the nozzle.

34. The method of claim 30 wherein the directed gas flow at least temporarily includes abrasive particles.

35. The method of claim 30 wherein the nozzle directs the gas flow at an angle that is perpendicular to the roller surface, wherein the nozzle is spaced 1-30 mm apart from the roller surface as the nozzle directs the gas flow.

36. The method of claim 30 wherein the suction duct is a first suction duct, the method further comprising removing glitter and dissolved contaminants by way of a second suction duct positioned across the width of the roller corresponding to the width of the strip-type material carried along or supported by the roller, with the second suction duct being disposed outside the hood in a region proximate at least one of the strip-type material or an adjacent roller.
